(19) United States
(12) Patent Application Publication
(10) Pub. No.: US 2014/0182423 A1
(43) Pub. Date: Jul. 3, 2014

(54) WRENCH ADAPTER

(71) Applicant: Qing-Xiang LIU, Taichung City (TW)

(72) Inventor: Qing-Xiang LIU, Taichung City (TW)

(21) Appl. No.: 13/733,547

(22) Filed: Jan. 3, 2013

(51) Int. Cl. B25B 23/00

(52) U.S. Cl. CPC B25B 23/0035
USPC 81/177.85

(57) ABSTRACT

A wrench adapter includes an adapter shaft having an adapter tip located at its one end and attachable to a wrench socket and a wrench adapter head located at its other end and defining therein a driven hole for receiving a tool bit, and a first wrench driven portion and a second wrench driven portion disposed at the periphery of the wrench adapter head at different elevations and drivable by open-end wrenches or adjustable wrenches of different sizes.

### BACKGROUND OF THE INVENTION

1. Field of the Invention

The present invention relates to wrench technology and more particularly to a wrench adapter that provides a plurality of wrench driven portions drivable by different sizes of wrenches.

2. Description of the Related Art

A conventional wrench adapter 1, as shown in FIG. 1, comprises an adapter tip 2 located at its one end and engageable with a socket and a wrench adapter head 3 located at its other end and engageable by a ratchet wrench. This design of socket wrench adapter 1 is insertable into a female screw member and drivable by a ratchet wrench to fasten or unfasten the female screw member. Further, according to this design, two or more socket wrench adapters can be connected in line to extend the length for application.

However, when operating a ratchet wrench to rotate the socket wrench adapter 1 with a ratchet wrench in loosening a screw member, the socket wrench adapter 1 and the screw member may be returned with the ratchet wrench after the screw member having been loosened to a certain extent. When continuously rotating the ratchet wrench at this time, the ratchet wrench will run idle. Further, the wrench adapter head 3 of wrench adapter 1 is configured for receiving a driving tip or a ratchet wrench, not directly drivable by an open-end wrench or adjustable wrench. Thus, the applicability of this design of wrench adapter is limited. If a matching ratchet wrench is not available, this design of wrench adapter becomes not applicable. Therefore, there is room for improvement.

### SUMMARY OF THE INVENTION

The present invention has been accomplished under the circumstances in view. It is the main object of the present invention to provide a wrench adapter, which provides a plurality of wrench driven portions drivable by different sizes of wrenches, enhancing wrench adapter applicability.

To achieve this and other objects of the present invention, a wrench adapter comprises an adapter shaft, an adapter tip located at one end of the adapter shaft and attachable to a wrench socket, a wrench adapter head located at an opposite end of the adapter shaft and defining therein a driven hole for receiving a tool bit, a first wrench driven portion located at the periphery of the adapter head, and a second wrench driven portion disposed at a different elevation relative to the first wrench driven portion. By means of the first wrench driven portion and the second wrench driven portion, the wrench adapter can be driven to rotate a screw member by different sizes of open-end wrenches, adjustable wrenches or box wrenches.

Further, a force-applying part is provided at the periphery of the adapter shaft and drivable by a wrench of a different size relative to the sizes of wrenches operable to rotate the first or second wrench driven portion.

Thus, when the applied wrench run idle during operation of the wrench adapter to loosen a screw member, a different size of open-end wrench or adjustable wrench can be selectively used and attached to the first wrench driven portion, second wrench driven portion or force-applying part to finish the screw member loosening work.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an elevational view of a wrench adapter according to the prior art.

FIG. 2 is an oblique elevational view of a wrench adapter in accordance with the present invention.

FIG. 3 is a schematic front view of the wrench adapter in accordance with the present invention.

FIG. 4 is a sectional view taken along line 4-4 of FIG. 3.

FIG. 5 is a sectional view taken along line 5-5 of FIG. 3.

FIG. 6 is a sectional view taken along line 6-6 of FIG. 3.

FIG. 7 is a schematic drawing illustrating the applicability of the wrench adapter in accordance with the present invention.

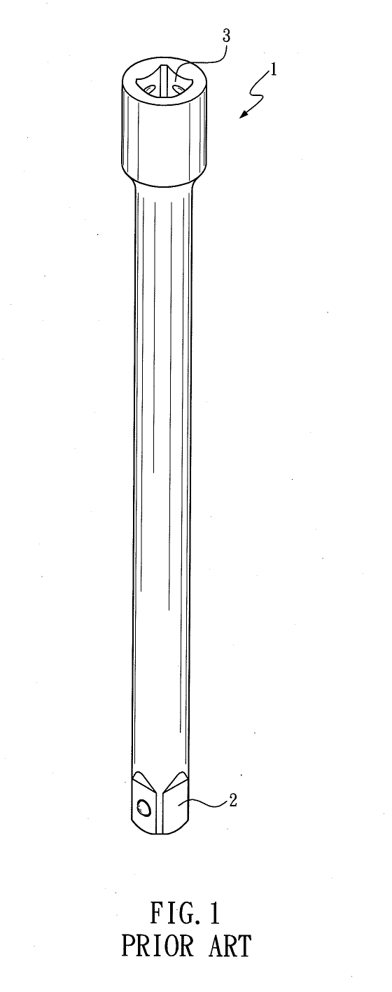

### DETAILED DESCRIPTION OF THE INVENTION

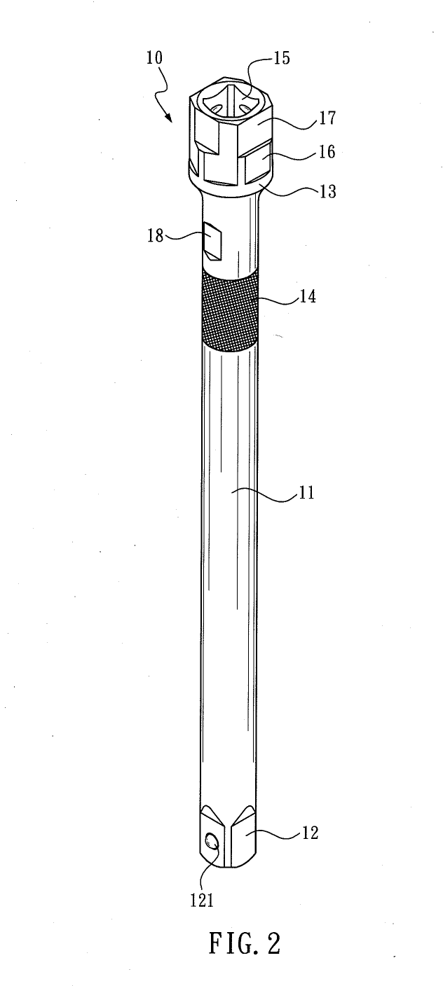

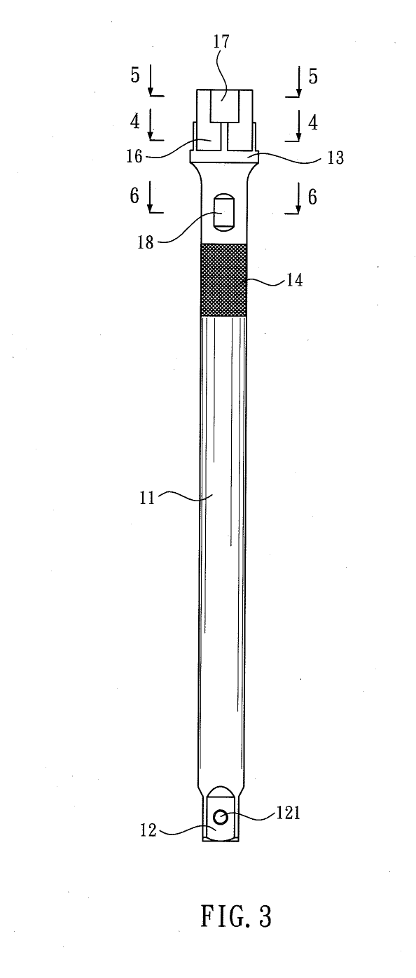

Referring to FIGS. 2 and 3, a wrench adapter 10 in accordance with the present invention is shown. The wrench adapter 10 comprises an adapter shaft 11, a wrench adapter tip 12, and a wrench adapter head 13.

The adapter shaft 11 is an elongated round rod having an embossed pattern 14 located at the periphery near the wrench adapter head 13 for enabling the user to pick up and hold the wrench adapter 10 conveniently and positively,

The adapter tip 12 is located at one end of the adapter shaft 11 remote from the embossed pattern 14 and configured for insertion into wrench socket (not shown), having a spring-supported steel ball 121 mounted in one of the multilateral periphery thereof for securing the adapter tip 12 to the inserted wrench socket.

The wrench adapter head 13 is located at an opposite end of the adapter shaft 11 and adjacent to the embossed pattern 14, defining therein a driven hole 15 for receiving a tool bit (not shown).

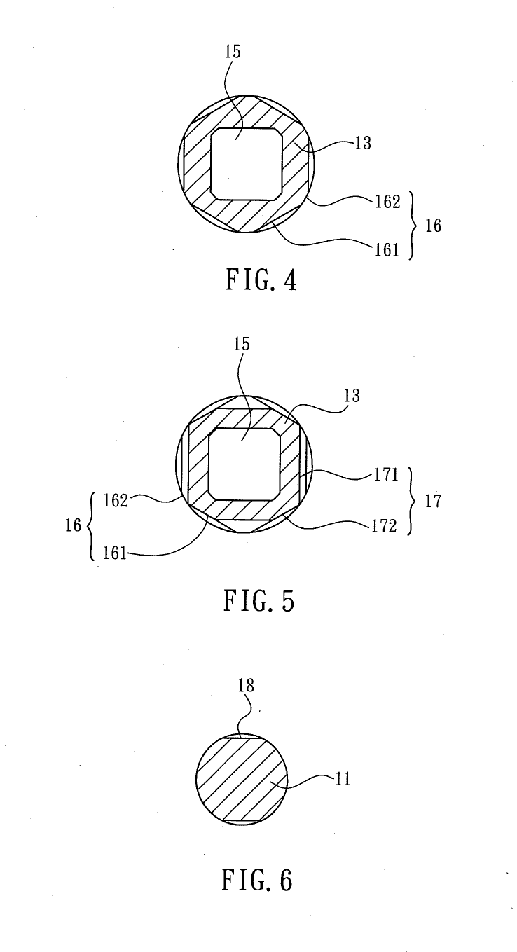

The wrench adapter 10 further comprises a first wrench driven portion 16 defining six abutment faces 161 and six angle corners 162 alternatively arranged around the periphery of the adapter head 13 at a relatively lower elevation (see FIG. 4), and a second wrench driven portion 17 defining four abutment faces 171 and four angle corners 172 alternatively arranged around the periphery of the adapter head 13 at a relatively higher elevation. Further, each angle corner 172 of the second wrench driven portion 17 is disposed with one respective abutment face 161 of the first wrench driven portion 16 on a same plane. Thus, the first wrench driven portion 16 and the second wrench driven portion 17 are respectively drivable by different sizes of wrenches, such as open-end wrenches, adjustable wrenches, or box wrenches. This arrangement eliminates wrench idle running problem when loosening a screw member, and enhances the applicability of the wrench adapter 10.

FIG. 6 is a sectional view taken along line 6-6 of FIG. 3. As illustrated, the wrench adapter 10 further comprises a force-applying part 18 located at the periphery of the adapter shaft 11 at a suitable location. According to the present preferred embodiment, the force-applying part 18 is formed of two cut planes located at the periphery of the adapter shaft 11 at two opposite sides between the adapter head 13 and the embossed pattern 14 drivable by an open-end wrench or adjustable wrench.

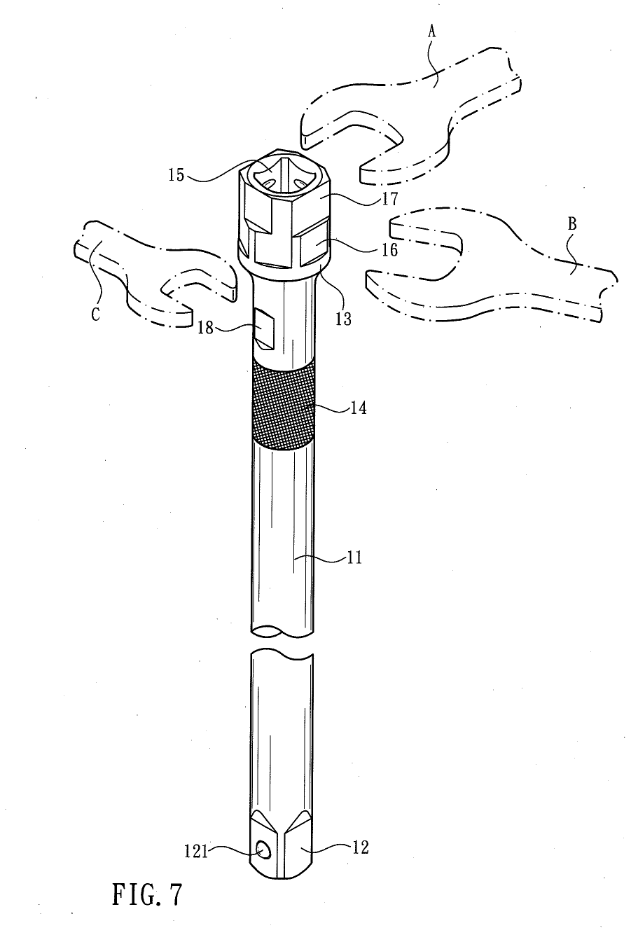

FIG. 7 is a schematic drawing illustrating the applicability of the wrench adapter in accordance with the present invention. Three different sizes of wrenches A, B and C (open-end wrenches or adjustable wrenches) can be selectively used and attached to the second wrench driven portion 17, the first wrench driven portion 16 or the force-applying part 18, respectively, and operated to rotate the wrench adapter 10 and the attached socket (not shown).

The so-called different sizes of (open-end or adjustable) wrenches refer to size differences in metric or English system.

When the ratchet wrench runs idle in rotating the wrench adapter 10 to loosen a screw member in a deep hole, the user can use an open-end wrench or adjustable wrench to substitute for the ratchet wrench and attach the open-end wrench or adjustable wrench to the first wrench driven portion 16, second wrench driven portion 17 or force-applying part 18 of the wrench adapter 10 and then operate the open-end wrench or adjustable wrench to rotate the wrench adapter 10 and the screw member in the deep hole, positively loosening the screw member.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

1. A wrench adapter, comprising:
an adapter shaft;
an adapter tip located at one end of said adapter shaft and attachable to a wrench socket;
a wrench adapter head located at an opposite end of said adapter shaft and defining therein a driven hole for receiving a tool bit;
a first wrench driven portion located at the periphery of said adapter head, said first wrench driven portion comprising six abutment fares and six angle corners alternatively arranged around the periphery of the adapter head, and drivable by a wrench of a first size; and
a second wrench driven portion disposed adjacent to said first wrench driven portion on an opposite side against said wrench adapter head, said second wrench driven portion defining for abutment faces and four angle corners alternatively arranged around the periphery of said adapter head, and drivable by a wrench of a second size different from said first size wherein angle corners of said second wrench driven portion are disposed with four of said abutment faces of said first wrench drive portion on a same plane.

2-4. (canceled)

5. The wrench adapter as claimed in claim 1, wherein angle corners of said second wrench driven portion are disposed with four of said abutment faces of said first wrench driven portion on a same plane.

6. The wrench adapter as claimed in claim 1, further comprises a force-applying part located at the periphery of said adapter shaft and drivable by a wrench of a third size different from said first size and said second size.

7. The wrench adapter as claimed in claim 6, wherein said force-applying part comprises two cut planes located at the periphery of said adapter shaft at two opposite sides.
